(19) United States
(12) Patent Application Publication
(10) Pub. No.: US 2018/0324484 A1
(43) Pub. Date: Nov. 8, 2018

(54) PROVIDING SUPPLEMENTAL CONTENT FOR MEDIA ASSETS

(71) Applicant: THOMSON LICENSING, Issy les Moulineaux (FR)

(72) Inventor: Arnaud RETUREAU, Los Angeles, CA (US)

(73) Assignee: THOMSON LICENSING, Issy les Moulineaux (FR)

(21) Appl. No.: 15/773,160

(22) PCT Filed: Nov. 4, 2015
(86) PCT No.: PCT/US2015/059036

§ 371 Date: May 2, 2018

(51) Int. Cl. H04N 21/431; H04N 21/81; H04N 21/2743; H04N 21/4402

(52) U.S. Cl. CPC H04N 21/4316; H04N 21/440245; H04N 21/2743; H04N 21/8133

(57) ABSTRACT

A method and apparatus for generating supplemental multimedia content for a media asset are described, including accessing a library of material on a server, the material representing pre-approved portions of the media asset for use in generating the supplemental multimedia content, generating the supplemental multimedia content by adding user supplied content related to the media asset to the pre-approved portions of the media asset and uploading the generated supplemental multimedia content for display with the media asset or a list of media assets.

### FIELD

The proposed method and apparatus relate to generation and posting (uploading) of supplemental multimedia content related to media (content) assets.

### BACKGROUND

In multicast and broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

This section is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

### SUMMARY

A method and apparatus for generating supplemental multimedia content for a media asset are described, including accessing a library of material on a server, the material representing pre-approved portions of the media asset for use in generating the supplemental multimedia content, generating the supplemental multimedia content by adding user supplied content related to the media asset to the pre-approved portions of the media asset and uploading the generated supplemental multimedia content for display with the media asset or a list of media assets. Also described are a method and apparatus for displaying user generated supplemental multimedia content, including receiving user generated supplemental multimedia content, matching the user generated supplemental multimedia content with a media asset using metadata included in the user generated supplemental multimedia content and also included in the media asset and forwarding the user generated supplemental multimedia content along with the media asset or a list of media assets to user equipment in response to a request for the media asset or the list of media assets.

### BRIEF DESCRIPTION OF THE DRAWINGS

The proposed method and apparatus is best understood from the following detailed description when read in conjunction with the accompanying drawings. The drawings include the following figures briefly described below:

FIG. 1 is a schematic diagram of an exemplary user interface with Media (Content, Multimedia Content) Asset Poster Art (being representative of a media (content, multimedia content, video) asset from M-Go) in accordance with the principles set forth herein.

FIG. 2 is a schematic diagram of the supplemental content (shown as a PIP) in a sample screen in an approved content zone in accordance with the principles set forth herein.

FIG. 3 is a flowchart of the operation of an exemplary server of a media (content) service provider in accordance with the principles set forth herein.

FIG. 4 is an example block diagram of the user equipment 400 in accordance with the principles set forth herein.

FIG. 5 is a block diagram of an exemplary system in accordance with the principles set forth herein.

FIG. 6 is a flowchart of the operation of an exemplary server of the media (content) service provider in accordance with the principles set forth herein.

It should be understood that the drawing(s) are for purposes of illustrating the concepts of the disclosure and are not necessarily the only possible configuration for illustrating the disclosure.

### DETAILED DESCRIPTION

It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

When using a media (content, multimedia content) download/streaming delivery service such as M-Go and the like, a user can use an interface to select between different media (content, multimedia content) titles (such as movies, television shows, music selections, and the like), where such media (content, multimedia content) can be purchased or rented in exchange for a specific price from a media (content, multimedia content) service provider. The media (content, multimedia content) service provider is accessed by the user through an interface to a web server operated by the content (media, multimedia content) service provider. For example, a media (content, multimedia content) asset can be rented for a first price and/or purchased for a second price.

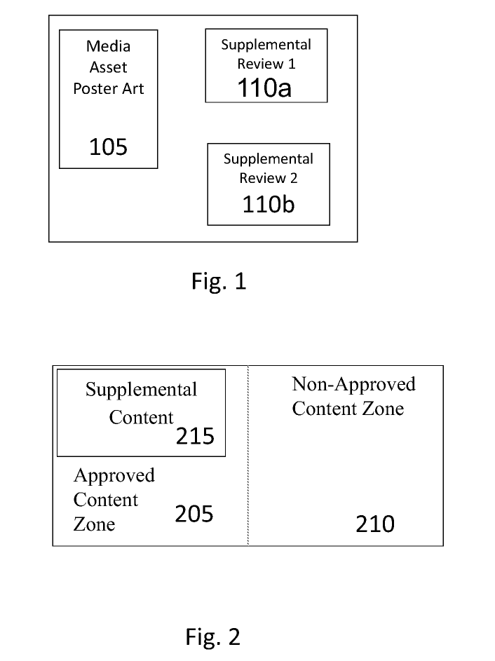

The proposed method and apparatus provides a framework for generating supplemental multimedia content such as movie reviews, tutorials, and the like which are paired with primary media (content, multimedia content) assets. For example, for a media (content, multimedia content) delivery system such as M-Go which offers media (content, multimedia content) assets, the supplemental multimedia content would be presented as supplemental content (media, multimedia content) when a user is presented with a media (content, multimedia content) asset or a listing of media (content, multimedia content) assets. That is, supplemental multimedia content is a combination of pre-approved portions of a media asset made available by a media service provider (such as Netflix or M-go) and user supplied content such as movie reviews, tutorials and the like. FIG. 1 shows an exemplary user interface with Media (Content, Multimedia Content) Asset Poster Art (105) (being representative of a media (content, multimedia content, video) asset from M-Go). Supplemental review 1 (110a) and supplemental review 2 (110b) of the media (content, multimedia content) would be user created videos (content, media, multimedia content) that are related to the media (content, multimedia content) asset. Preferably, a server is implemented which uses metadata to match up media (content, multimedia content) asset titles with related supplemental reviews. Alternative approaches can be taken to match up media (content, video, multimedia content) asset titles and related videos.

In the creation of supplemental video (content, media, multimedia content) assets, a library of material (from the content creator of a media (content, video, multimedia content) asset) is made available to the authors of such supplemental video (content, media, multimedia content) assets. The material represents pre-approved content (media, video, multimedia content) that the content creator has approved for use in making reviews about a media (content, video, multimedia content) asset, fan made home page for a media (content, video, multimedia content) asset, commentary about a media (content, video, multimedia content) asset, and the like. The pre-approved content (media, video, multimedia content) can be embedded with watermarks, security marks, and other descriptors that can used to identify the source of the approved content (media, video, multimedia content) when such content (media, video, multimedia content) is included within a supplemental video (media, content, multimedia content) asset. The pre-approved content (media, video, multimedia content) is located on a server to which users have pre-registered to access, an open server where the security marks (et al.) are used to track such content (media, video, multimedia content), and the like.

If the supplemental content (media, video, multimedia content) is then posted to a service where advertisements are made available, there is a revenue split between the content (media, video, multimedia content) creator and the author of the supplemental content (media, video, multimedia content) where based on the security marks, the service can determine how much of a video (content, media, multimedia content) is generated by the author and how much of the supplemental video (content, media, multimedia content) is supplied from the content (media, video, multimedia content) creator. The revenue for the advertisement would then be split accordingly. For example, if 10% of a review of a media (content, video, multimedia content) asset is from material supplied from a content (media, video, multimedia content) creator; the content (media, video, multimedia content) creator (owner) receives 10% of the advertisement revenues and the supplemental content (media, multimedia content, video) owner (creator) receives 90% from such revenues.

In an optional embodiment, rules (guidelines, methods, procedures) can be created by a content (media, video, multimedia content) owner. The rules (guidelines, methods, procedures) govern how the material can be used by a supplemental content (media, video, multimedia content) author. For example, a content (media, video, multimedia content) owner may not want there to be an overlay with text over the pre-approved supplied material (media, content, video, multimedia content), or have the content (media, video, multimedia content) modified (shown as part of a POP/PIP) with other content (media, video, multimedia content) when supplemental content (media, video, multimedia content) is generated. These rules (methods, procedures, guidelines) are enforced by using various image detection techniques to determine where in a unit of supplemental content (media, video, multimedia content) the additional pre-approved material (from a content (media, video, multimedia content) owner) is located and determine whether or not such material has been modified (size, different color, text overlay, etc.). For example, in FIG. 2, the supplemental content (215) (shown as a PIP) is shown in a sample screen in an approved content zone (205) (where the content owner would want the content to be shown in the left hand side of a screen, and have a person or object on the right side of the screen (210)). Other examples of such content (media, video, multimedia content) rules (methods, guidelines, procedures) can be enforced in accordance with the disclosed principles.

The server of the media (content) service provider determines media assets to be recommended to the user responsive to a user profile. Media assets of the media (content) provider may be in the range of 30,000 to 100,000 media (content) titles (assets). The user profile includes at least genre, prior purchase selections, prior rental selections and demographic information. The user may select one or more of the media (content) provider's media assets. The user is not limited to selecting from among the recommended media (content) assets but may select from among any of the media (content) provider's media assets.

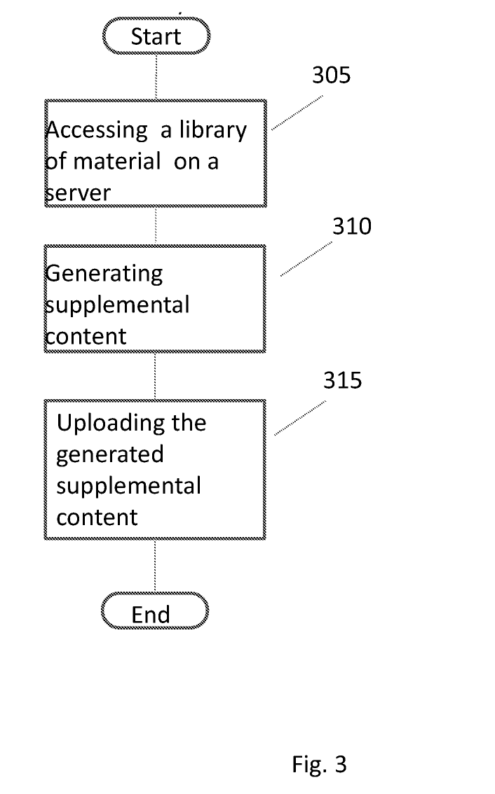

FIG. 3 is a flowchart of the generation of supplemental content in accordance with the principles set forth herein. At 305 a user accesses a library of material on a server of the media (content) service provider. The library of material represents pre-approved portions of media assets for use in generating supplemental multimedia content. At 310 the user generates the supplemental content related to the media assets. User supplied content is audio content or video content or multimedia content or any combination of audio content, video content and multimedia content. The user generated supplemental multimedia content includes both the pre-approved portions of media assets retrieved by the user through the access module and the user's supplied content (reviews, commentary and/or fan (user) home pages or portions thereof or any combination thereof). At 315 the user uploads the generated supplemental multimedia content for display with the media assets or with a list of media assets to the server. Users can then select media assets to render.

The user generated supplemental content is available to any users accessing the server for selection, downloading (or streaming) and rendering of the media assets. Users accessing the server to select media assets for rendering on their display device can select if they want to view the generated supplemental content. For example, users having small children may want to see reviews of media assets by other parents. Other users may want to see (view) media assets and may not want to be swayed by the inclusion of reviews or commentary by other users before rendering (viewing, displaying). The user supplied content may be reviews, commentary or fan (user) generated home pages or any combination thereof. The pre-approved portions of the media assets available to users for use in generating the supplemental content may be embedded with watermarks, security marks, metadata and/or other descriptors that can be used to identify a source of the pre-approved portions of the media assets when the pre-approved media assets are included in the user generated supplemental content. The library of pre-approved portions of the media assets is available to pre-registered users. The user generated supplemental content is displayed in an approved zone of a display device. The pre-approved portions of media assets can only be modified by the user in accordance with rules which govern modification of the pre-approved portion of the media assets. The user generated supplemental content is matched with the media assets using the metadata. The user generated supplemental content is displayed with the media assets matched with it.

The user's equipment may include a processor that is programmed to operate as indicated in the flowchart of FIG. 3 or the user equipment may include modules that are hardware or firmware including, but not limited to, application specific integrated circuits (ASICs), reduced instruction set computers (RISCs), field programmable gate arrays (FPGAs) or the like. The user's equipment also includes a display to render the media assets and to be used in generating the supplemental multimedia content.

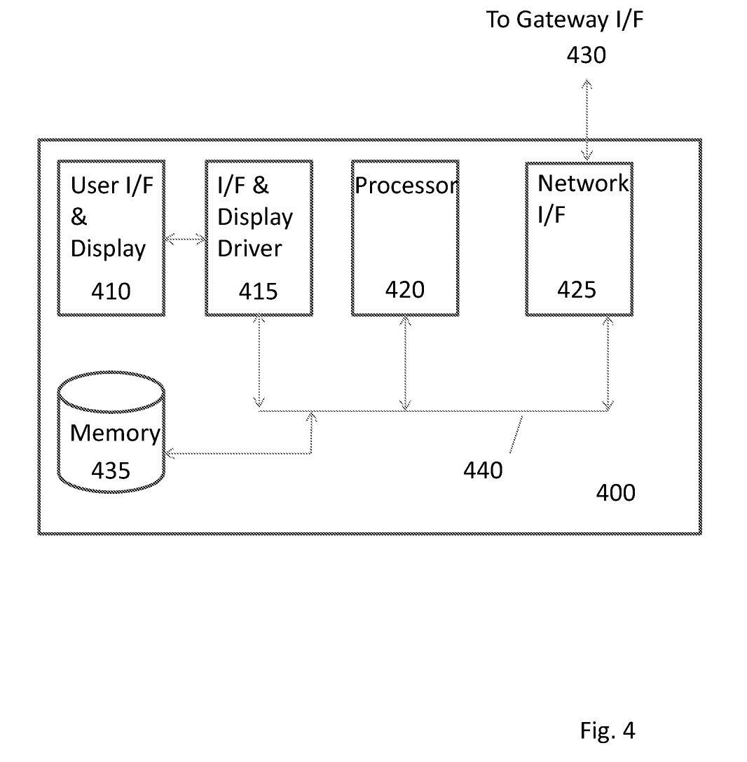

FIG. 4 is an example block diagram of user equipment 400. The block diagram configuration includes a bus-oriented 440 configuration interconnecting a processor 420, and a memory 435. The configuration of FIG. 4 also includes a network interface 430 to a gateway, such as router, bridge or brouter. The router, bridge or brouter may utilize either a wired or a wireless interface to the user equipment.

Processor 420 provides computation functions for the user equipment. The processor 420 can be any form of CPU or controller that utilizes communications between elements of the media device to control communication and computation processes. Those of skill in the art recognize that bus 440 provides a communication path between the various elements of embodiment 400 and that other point-to-point interconnection options (e.g. non-bus architecture) are also feasible.

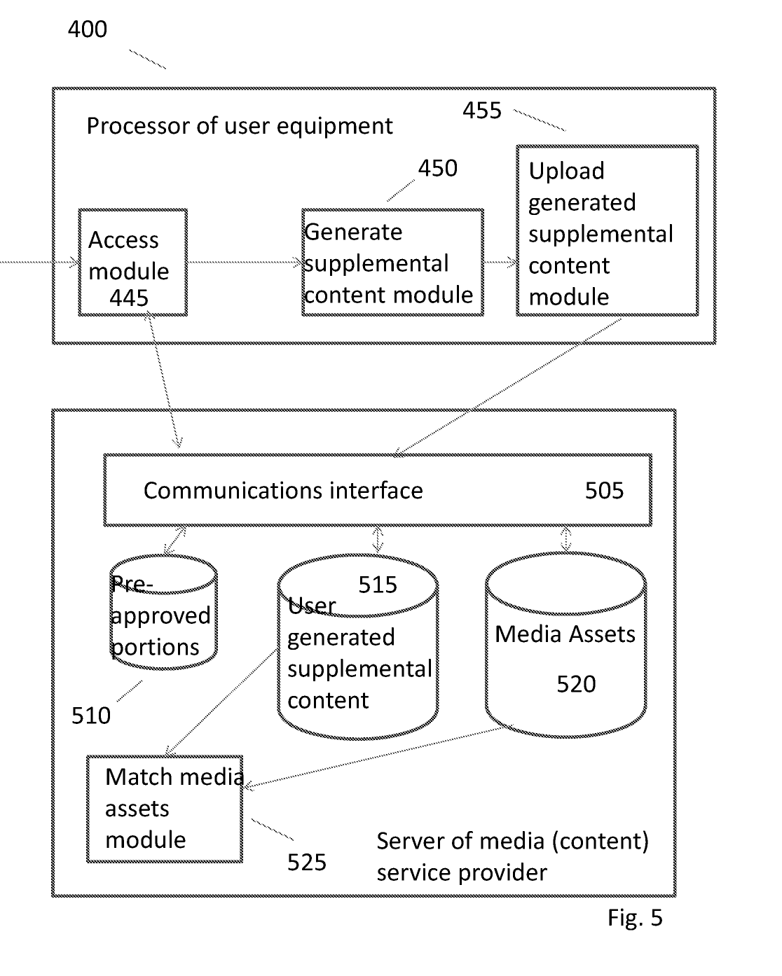

Memory 435 can act as a repository for memory related to any of the methods that incorporate the functionality of the user equipment. Memory 435 can provide the repository for storage of information such as program memory, downloads, uploads, or scratchpad calculations as well as the storage of pre-approved portions of media assets retrieved by the access module (shown in FIG. 5). Those of skill in the art will recognize that memory 435 may be incorporated in all or in part of processor 420. Network interface 425 has both receiver and transmitter elements for communication as known to those of skill in the art.

User interface and display 410 is driven by interface circuit 415. The user interface and display 410 is used as a multimedia interface having both audio and video capability to display media assets and/or the pre-approved portions of the media assets obtained via network interface 425 and connection 425 to a network. The user interface and display 410 also allows the user of the user equipment to render selected media assets downloaded or streamed from the server of a media (content) service provider.

FIG. 5 is a block diagram of an exemplary system in accordance with the principles set forth herein. The processor of the user equipment shown in FIG. 5 includes an access module (445) which accesses server to retrieve the pre-approved portions of the media assets. The access module accesses the server through the network interface (I/F) (425) and gateway interface (I/F) (430). The access module accesses a library of material. The library of material represents pre-approved portions of media assets for use in generating supplemental content. The access module provides the retrieved pre-approved portions of the media assets from the library of material to the generate supplemental content module (450), which generates the supplemental multimedia content. User supplied content is audio content or video content or multimedia content or any combination of audio content, video content and multimedia content. The user supplied content can include reviews, commentary and/or fan (user) home pages or portions thereof as well as the pre-approved portions of media assets retrieved by the access module or any combination thereof. The generate supplemental content module forwards the user generated supplemental content to the upload generated supplemental content module (455), which uploads the user generated supplemental content to the server of the media (content) service provider for display with the media assets or with a list of media assets. Users can then select media assets to render.

The user generated supplemental content includes both the pre-approved portions of media assets retrieved by the user through the access module and the user's supplied content (e.g., reviews, commentary and/or fan (user) home pages or portions thereof or any combination thereof). The user generated supplemental content is available to any users accessing the server for selection, downloading (or streaming) and rendering of media assets. Users accessing the server to select media assets for rendering on their display device can select if they want to view the generated supplemental multimedia content. For example, users having small children may want to see reviews of media assets by other parents. Other users may want to see (view) media assets and may not want to be swayed by the inclusion of reviews or commentary by other users before rendering (viewing, displaying).

The pre-approved portions of the media assets available to users for use in generating the supplemental multimedia content may be embedded with watermarks, security marks, metadata and/or other descriptors that can be used to identify a source of the pre-approved portions of the media assets when the pre-approved media assets are included in the user generated supplemental multimedia content. The library of pre-approved portions of the media assets is available to pre-registered users. The user generated supplemental content is displayed in an approved zone of a display device. The pre-approved portions of media assets can only be modified by the user in accordance with rules which govern modification of the pre-approved portion of the media assets. The user generated supplemental content is matched with the media assets using the metadata. The user generated supplemental content is displayed with the media assets matched with it.

FIG. 5 also shows the server (500) of the media (content) service provider. The server includes one or more memory units or data bases. One memory unit (data base) stores the pre-approved portions of media assets (510). Another memory unit (data base) receives the user generated supplemental multimedia content (515). A third memory (data base) stores the media assets (520) that the server of the media (content) service provider offers to users for selection, downloading (or streaming) and rendering on a user's display device. The memory units (data bases) may be separate or may be a single memory device with segregated portions of memory to store the various units (portions) of information. The server also includes a match media assets module (525) which matches the media assets to the user generated supplemental content using metadata. The server also includes a communications interface (505) through which the server communicates with the user equipment and vice versa.

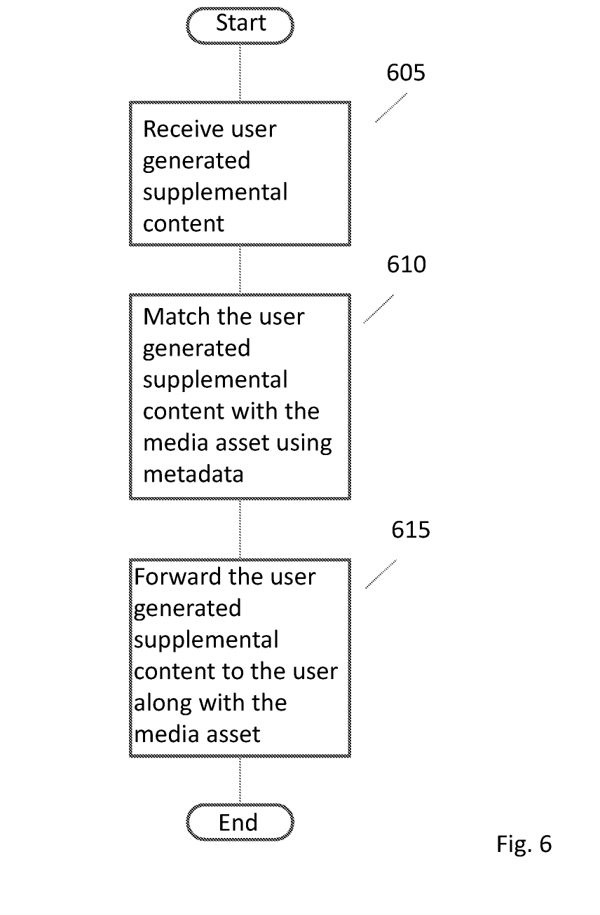

FIG. 6 is a flowchart of the operation of an exemplary server of the media (content) service provider in accordance with the principles set forth herein. At 605 the server receives user generated supplemental content. At 610 the server matches the user generated supplemental content with a media asset using metadata included in the user generated supplemental content and also included in the media asset. At 615 the server forwards the user generated supplemental content along with the media asset or a list of media assets to user equipment in response to a request for the media asset or the list of media assets.

It is to be understood that the proposed method and apparatus may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the proposed method and apparatus are implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

It is to be further understood that, because some of the constituent system components and method steps depicted in the accompanying figures are preferably implemented in software, the actual connections between the system components (or the process steps) may differ depending upon the manner in which the proposed method and apparatus is programmed. Given the teachings herein, one of ordinary skill in the related art will be able to contemplate these and similar implementations or configurations of the proposed method and apparatus.

1. A method for generating supplemental multimedia content for a media asset, said method comprising:
accessing a library of material on a server, said material representing pre-approved portions of said media asset for use in generating said supplemental multimedia content;
generating said supplemental multimedia content by adding user supplied content related to said media asset to said pre-approved portions of said media asset; and
uploading, to the server, said generated supplemental multimedia content for display with said media asset or a list of media assets.

2. The method according to claim 1, wherein said user supplied content includes reviews, commentaries or user home pages.

3. The method according to claim 1, wherein said pre-approved portions of said media asset includes embedded watermarks, security marks, metadata or other descriptors that can be used to identify a source of said pre-approved portions of said media asset when said pre-approved portions of said media asset are included in said generated supplemental multimedia content.

4. The method according to claim 1, wherein said library of material on said server is available to pre-registered users.

5. The method according to claim 1, wherein further comprising displaying said generated supplemental multimedia content in an approved zone of a display.

6. The method according to claim 1, further comprising modifying said pre-approved portions of said media asset in accordance with rules which govern modification of said pre-approved portions of said media asset.

7. A method for displaying user generated supplemental multimedia content, said method comprising:
receiving user generated supplemental multimedia content;
matching said user generated supplemental multimedia content with a media asset using metadata included in said user generated supplemental multimedia content and also included in said media asset; and
forwarding said user generated supplemental multimedia content along with said media asset or a list of media assets to user equipment in response to a request for said media asset or said list of media assets.

8. The method according to claim 7, displaying said user generated supplemental multimedia content in an approved zone of a display.

9. An apparatus for generating supplemental multimedia content for a media asset, comprising:
an access module, said access module accessing a library of material on a server, said material representing pre-approved portions of said media asset for use in generating said supplemental multimedia content;
a generate supplemental multimedia content module, said generate supplemental multimedia content module generating said supplemental multimedia content by adding user supplied content related to said media asset to said pre-approved portions of said media asset, said generate supplemental multimedia content module being in communication with said access module; and
an upload generated supplemental multimedia content module, said upload generated supplemental multimedia content module uploading, to the server, said generated supplemental multimedia content for display with said media asset or a list of media assets, said upload generated supplemental multimedia content module being in communication with said generate supplemental multimedia content module, said upload generated supplemental multimedia content module being in communication with said server.

10. The apparatus according to claim 9, wherein said user supplied content includes reviews, commentaries or user home pages.

11. The apparatus according to claim 9, wherein said pre-approved portions of said media asset includes embedded watermarks, security marks, metadata or other descriptors that can be used to identify a source of said pre-approved portions of said media asset when said pre-approved portions of said media asset are included in said generated supplemental multimedia content.

12. The apparatus according to claim 9, wherein said library of material on said server is available to pre-registered users.

13. The apparatus according to claim 9, further comprising displaying said user generated supplemental multimedia content in an approved zone of a display.

14. The apparatus according to claim 9, further comprising modifying said pre-approved portions of said media asset in accordance with rules which govern modification of said pre-approved portions of said media asset.

15. A server of a media service provider for displaying user generated supplemental multimedia content, comprising:
a communications interface, said communications interface receiving user generated supplemental multimedia content and storing said user generated supplemental multimedia content in a first storage unit;
a matching media assets module, said matching media assets module matching said user generated supplemental multimedia content with a media asset using metadata included in said user generated supplemental multimedia content and also included in said media asset, said media assets stored in a second storage unit; and
said communications interface forwarding said user generated supplemental multimedia content along with said media asset or a list of media assets to user equipment in response to a request for said media asset or said list of media assets.

16. The server according to claim 15, further comprising displaying said user generated supplemental multimedia content in an approved zone of a display.

17. The server according to claim 15, wherein said first storage unit and said second storage unit are co-located or are a single storage unit portioned for storing said media assets and said user generated supplemental multimedia content.
